(19) United States
(12) Patent Application Publication
(10) Pub. No.: US 2002/0161621 A1
(43) Pub. Date: Oct. 31, 2002

(54) System for and method of remotely qualifying a prospect for a data stream transformation project

(76) Inventor: Robert W. Anthony, Wellesley, MA (US)

Correspondence Address: CHOATE, HALL & STEWART, A PARTNERSHIP INCLUDING PROFESSIONAL CORPORATIONS, EXCHANGE PLACE, 53 STATE STREET, BOSTON, MA, 02109-2891, US

(21) Appl. No.: 09/776,255

(22) Filed: Feb. 2, 2001

(51) Int. Cl. G06F 17/60

(52) U.S. Cl. 705/10

(57) ABSTRACT

A method of and apparatus for remotely qualifying a prospective customer's (prospect) data stream transformation project. The invention employs a remote qualifier site communicatively connected to a prospect site and an Internet host. A remote qualifier remotely qualifies the prospect's data steam transformation project by executing steps including determining a prospect's business initiative, conducting a cost versus benefit analysis, determining a client device interface targeted by the data stream transformation project, inquiring about existing host systems of the prospect, searching for similar prior data stream transformation projects, inquiring about data stream transformation project deployment timing, inquiring about alternative approaches to accomplish the data stream transformation project, rejecting the prospect as unqualified if the prospect was determined to be unqualified in a previous step, requesting a signature on a mutual nondisclosure agreement, determining whether the data stream transformation project can use a standard estimate or if it needs further development by an engineering team, sending information to a engineering team for an estimate if the data stream transformation project was determined to need further development, or alternatively generating a standard estimate if the data stream transformation project was determined not to need further development, and gathering contact information.

### FIELD OF THE INVENTION

The present invention relates generally to a method and apparatus for remotely qualifying a prospective customer's data stream transformation project. More specifically, the invention assists in determining the feasibility of a data stream transformation project at an early stage and with low overhead cost by enabling the qualification to be performed remotely. The invention has potential application in the field of business software.

### BACKGROUND OF THE INVENTION

Data stream transformation is one method of converting an existing host application from a previous organization and operation to another organization and operation. Generally, the data stream transformation provides better functionality or new operations that the previous application could not.

A typical sale of such technology involves synchronizing the buyer's expectation of the function and fit of the technology within their current system, and the data stream transformation vendor's experience with the system. In the conventional approach to application design, the buyer must pay in advance for a lengthy process that includes conceptual, functional, and detail designs. These designs are required just to gauge the scope of the process, and are time-consuming and expensive, especially the detail design, requiring costly travel and personnel time. Moreover, a customer can invest a great deal of money in the project only to find it to be infeasible.

Risk management is also a major concern of customers that need to convert an existing host application. Even during the design phase, the vendor must take care to avoid corrupting the customer's system. Unless the system is unusually well documented, an extensive probing of the system by the designers is inevitable. Although such an invasive approach can threaten software or data, it is required to minimize the risk in the actual integration. The vendor that can mitigate these risks inherent in a data stream transformation project, improve project turnaround time, and lower costs can capture a large portion of the existing demand for such services.

Testing an existing host system to see if its data stream can be transformed in a practical way conventionally involves actual tests performed on the physical system, particularly if the system is not meticulously documented. Such tests may corrupt system elements such as tables and data files. What is needed is a way to minimize the risk of corrupting a system when qualifying a data stream transformation project.

Data stream transformation projects, like most application upgrades, involve weeks-long site visits by consulting personnel to evaluate the system and estimate the feasibility, cost, and duration of the transformation. What is needed is a way to more rapidly define the scope and schedule of a data stream transformation project.

The customer may not know the net economic benefit of a data stream transformation project until after the transformation is implemented. In the end, the benefits may not justify the cost of transforming the data stream. What is needed is a way to determine the return on the investment in a data stream transformation project while it is in the evaluation stage.

Detailed design analysis can be costly due to travel expenses and time spent by both vendor and customer personnel. Vendor personnel often spend weeks traveling to and working at the customer site, which can be at a remote distance from the vendor's site, before the project has even begun. What is needed is a way to design the scope and schedule of a data stream transformation project free of charge.

Qualifying a prospective customer usually requires a detailed design analysis of a customer's system, which in turn calls for lengthy on-site visits, and consequent high costs from travel and personnel time. What is needed is a way to qualify a prospect without the overhead cost of visiting the prospect's location.

One way to solve these problems is to use the conventional sequence of conceptual, functional, and detail designs. However, evaluating a project in the conventional manner takes weeks or months to accomplish, and costs a great deal of money. Thus, alternative means are needed.

### SUMMARY OF THE INVENTION

In one aspect, the invention is a system for remotely qualifying a prospect's data stream transformation project proposal. The system comprises a remote qualifier site, a prospect site, and an Internet host. The remote qualifier site includes a phone, a fax machine, and a remote qualifier computer further including a qualifier database, an e-mail client, a modem, and a Web browser. The prospect site includes a prospect phone, a prospect fax, and a host computer communicatively connected to the remote qualifier computer. The host computer further includes a data storage device, host applications and one or more data streams, a prospect e-mail client, a modem, and a prospect Web browser. A person referred to as a “remote qualifier”, situated at the remote qualifier site, performs the following steps in order to remotely qualify the prospect's data stream transformation project proposal: determining the prospect's business initiative; conducting a cost versus benefit analysis; determining a client device interface targeted by the data stream transformation project; inquiring about the prospect's host computer, host applications and data stream(s), network and interface; searching for similar prior data stream transformation projects; inquiring about the data stream transformation project deployment timing; inquiring about alternative approaches; requesting a signature on a mutual nondisclosure agreement; determining whether the data stream transformation project may use a standard estimate or if it needs further development by an engineering team and sending information regarding the data stream transformation project to a engineering team for an estimate if the data stream transformation project was determined to need further development, or alternatively generating a standard estimate if the data stream transformation project was determined not to need further development; and gathering contact information. After each step, the remote qualifier determines whether the prospect remains qualified or whether the prospect should be rejected as unqualified.

In another aspect, the invention is a method for remotely qualifying a prospect for a data stream transformation project. The method comprises the method steps recited above as being performed by the remote qualifier located at the remote qualifier site.

### BRIEF DESCRIPTION OF THE DRAWINGS

FIG. 1 is a schematic diagram illustrating a system for remotely qualifying a prospect data stream transformation project.

FIG. 2 is a flow diagram illustrating a first portion of a method of remotely qualifying a data stream transformation project.

FIG. 3 is a flow diagram illustrating a second portion of a method of remotely qualifying a data stream transformation project.

### DETAILED DESCRIPTION

Preferred embodiments of the invention will now be described with reference to the accompanying drawings.

System for Remotely Qualifying a Prospect

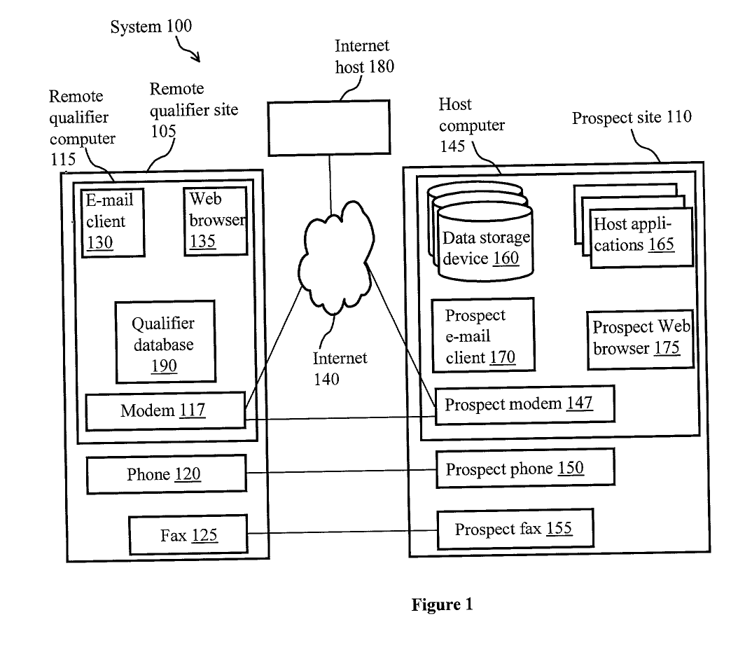

In one aspect, the invention is a system 100, as depicted in FIG. 1, for remotely qualifying a prospective customer for a data stream transformation project. System 100 includes a remote qualifier site 105, a prospect site 110, and an Internet host 180. A “remote qualifier” is a person who acquires the necessary information about a prospective customer for a data transformation project, and then qualifies or disqualifies the customer based on that information. Remote qualifier site 105 includes a remote qualifier computer 115, a phone 120, and a fax 125. Remote qualifier computer 115 further includes a modem 117, an e-mail client 130, and a Web browser 135. A qualifier database 190 currently resides on the Internet host 180. It could alternatively reside on the remote qualifier computer 115. Prospect site 110 includes a host computer 145, a prospect phone 150, and a prospect fax 155. Host computer 145 further includes a prospect modem 147, a data storage device 160, one or more host applications 165, a prospect e-mail client 170, and a prospect Web browser 175.

In operation, the remote qualifier at the remote qualifier site 105 may use the remote qualifier computer 115 to communicate with a prospect at prospect site 110 in several ways. The remote qualifier can use e-mail client 130 to send messages to prospect e-mail client 170 via Internet 140. The remote qualifier can access the host computer 145 with Web browser 135 via Internet 140. The remote qualifier also has the option of communicating or sending messages using phone 120 or fax 125. The prospect receives messages via prospect phone 150 or prospect fax 155, respectively. The remote qualifier may also use modem 117 to connect directly to host computer 145 via prospect modem 147, which enables the remote qualifier to access components of host computer 145, including data storage device 160 and host applications 165. Prospect uses prospect Web browser 175 to access historical information on qualifier database 190. Additional communication means are within the scope of the invention.

Method of Remotely Qualifying a Prospect

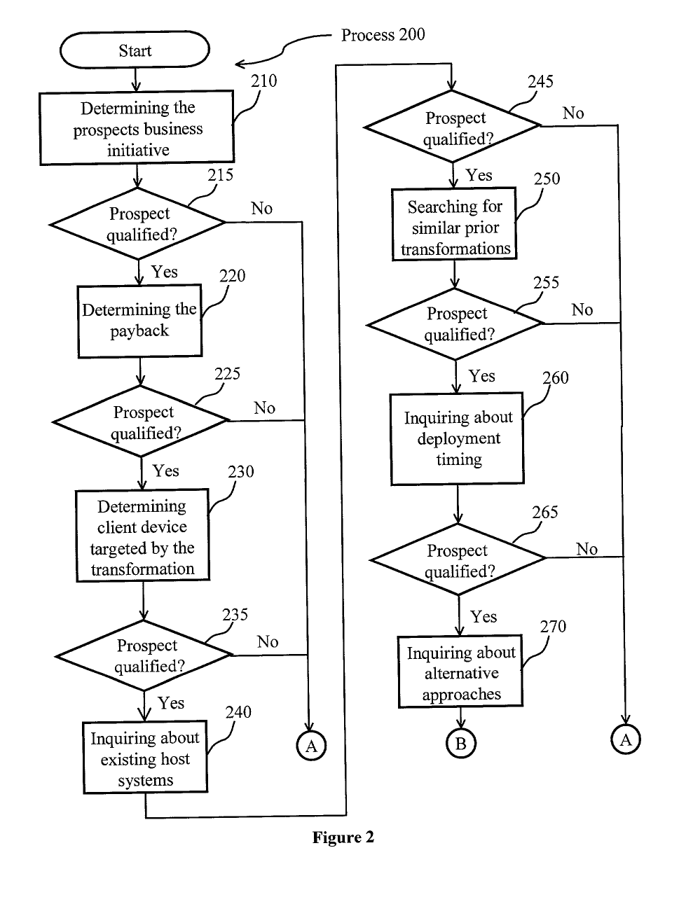

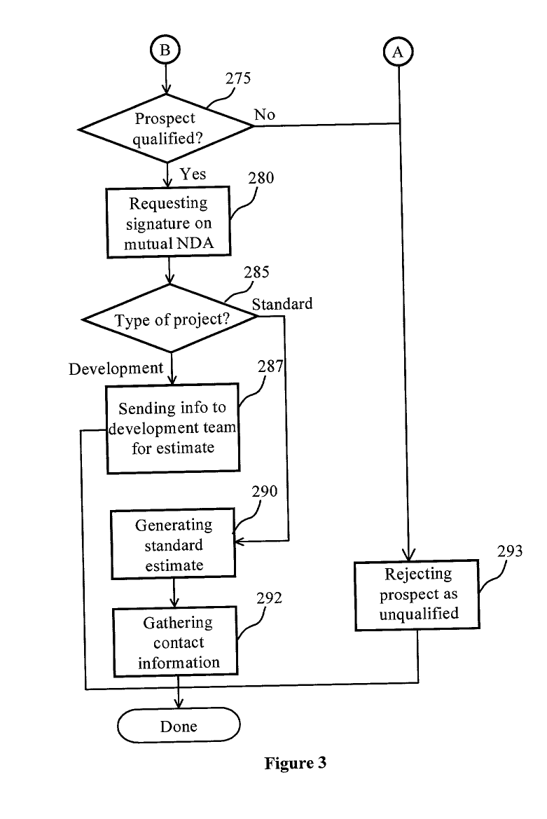

In another aspect, the invention is a method of remotely qualifying a prospect for a data stream transformation project. Such a method is now described with reference to FIGS. 2 and 3.

Step 210: Determining the Prospect's Business Initiative

In this step, the vendor's remote qualifying personnel (the remote qualifier) verifies with the prospective customer (the prospect) that the data stream transformation project being considered is in one of the vendor's current areas of interest. The remote qualifier also determines whether the vendor has sufficient in-house or accessible external expertise to confidently work in the business area defined by the desired transformation. Step 210 corresponds to Appendix A (Prospect Qualification Form), Question 1.

Step 215: Prospect Qualified?

In this decision step, the remote qualifier determines whether the prospect meets the conditions outlined in step 210. If yes, the prospect is still qualified and process 200 proceeds to step 220; if no, process 200 proceeds to step 293 (shown in FIG. 3 and described below).

Step 220: Determining the Payback

In this step, the remote qualifier determines the economic benefit to the prospect of the data stream transformation under consideration. The remote qualifier estimates how much the prospect will make or save with this transformation, compared with the cost of doing the transformation. Step 220 corresponds to Appendix A, Question 2.

Step 225: Prospect Qualified?

In this decision step, the remote qualifier determines whether the data stream transformation makes economic sense under the criteria in step 220. If yes, the prospect is still qualified and process 200 proceeds to step 230; if no, process 200 proceeds to step 293.

Step 230: Determining Client Device Targeted by the Transformation

In this step, the remote qualifier determines what kind of client device interface the data stream transformation is targeting. Client devices include wireless devices, such as cell phones and pagers, and stationary devices, such as Internet appliances. The remote qualifier also determines if the transformation for a Web-based appliance will be integrated into the prospect's existing Web site. Step 230 corresponds to Appendix A, Questions 3 and 4.

Step 235: Prospect Qualified?

In this decision step, the remote qualifier determines whether the client device can be accommodated (for example, if it is not an off-line device). If yes, the prospect is still qualified and process 200 proceeds to step 240; if no, process 200 proceeds to step 293.

Step 240: Inquiring about Existing Host Systems

In this step, the remote qualifier inquires about the prospect's existing host computer, application, network, and interface. Sample inquiries include whether the transformation will be porting data from one operating system to another, or from a wired application to a wired client device, and whether the vendor has experience on the host systems. Step 240 corresponds to Appendix A, Questions 5 and 6.

Step 245: Prospect Qualified?

In this decision step, the remote qualifier determines whether the prospect's host systems, sometimes in consultation with other vendor engineers, can be accommodated. Examples of disqualified host systems include stand-alone personal computers running applications for a single user. If yes, the prospect is still qualified and process 200 proceeds to step 250; if no, process 200 proceeds to step 293.

Step 250: Searching for Similar Prior Transformations

In this step, the remote qualifier directs the prospect to the vendor's Web site to search for previous data stream transformations similar to what the prospect is currently proposing. The prospect uses prospect Web browser 175 to access qualifier database 190 via Internet 140.

Step 255: Prospect Qualified?

In this decision step, the remote qualifier determines whether the prospect is still qualified based on information gathered in the previous step. An example of a candidate for disqualification is one in which there is no similar data stream transformation appearing in the vendor's historical database. If yes, process 200 proceeds to step 260; if no, process 200 proceeds to step 293.

Step 260: Inquiring about Deployment Timing

In this step, the remote qualifier asks for a deadline for deployment of the data stream transformation. Step 260 refers to Appendix A, Question 7.

Step 265: Prospect Qualified?

In this decision step, the remote qualifier determines whether there is sufficient time available for deployment and that the timeline does not extend too far into the future. If yes, the prospect is still qualified and process 200 proceeds to step 270; if no, process 200 proceeds to step 293.

Step 270: Inquiring about Alternative Approaches

In this step, the remote qualifier inquires about other possible ways to accomplish the data stream transformation. These can include other vendors, upgrading the host systems, or simply some other superior approach. Step 270 refers to Appendix A, Question 8.

Step 275: Prospect Qualified?

Referring to FIG. 3, in step 275, the remote qualifier determines whether no other data stream transformation approaches are found preferable. If yes, the prospect is still qualified and process 200 proceeds to step 280; if no, the process 200 proceeds to step 293.

Step 280: Requesting Signature on Mutual NDA

In this step, the remote qualifier asks for the prospect's signature on a mutual nondisclosure agreement.

Step 285: Determining the Type of Project

In this decision step, the remote qualifier determines whether this data stream transformation is a standard project or one that requires further development. A standard project is one with which the vendor is confidently experienced; that is, it is clearly within the vendor's capabilities, the vendor can confidently deliver the project on time, and the transformation makes clear economic sense for the prospect. A development project involves a novel data stream transformation; this is one with which the vendor has no direct experience but, in the judgment of the remote qualifier, can be successfully carried out after the vendor's engineering development team has worked out the budget, scope, and timing. If the project is standard, process 200 proceeds to step 290. If the project is a development project, process 200 proceeds to step 287.

Step 287: Sending Information to Development Team for Estimate

In this step, the remote qualifier relays the information gathered from the prospect to an engineering team, who estimate the budget, scope, and timing of the project to determine a schedule and a price.

Process 200 terminates after step 287.

Step 290: Generating a Standard Estimate

In this step, the remote qualifier generates a document that details the scope, schedule, and price of the data stream transformation under consideration. This step can be automated on a Web form, where final price figures can be immediately displayed, or done manually, in which case it can be transmitted by phone, mail, e-mail, or fax.

Step 292: Gathering Contact Information

In this step, the remote qualifier gathers contact information from the prospect on the Prospect Qualification Form (Appendix A, pages 3-5). To maintain momentum in the execution of the data stream transformation project, the vendor needs timely access to the proper authority at the customer's company. The detailed contact information gathered in this step facilitates such access.

Process 200 terminates after step 292.

Step 293: Rejecting Prospect as Unqualified

In this step, the remote qualifier rejects the prospect as unqualified based on information gathered in step 210, 220, 230, 240, 250, or 260.

Process 200 terminates after step 293.

One advantage of the present invention is that it minimizes the risk of corrupting a system when qualifying a data stream transformation project. The invention also allows definition of the scope and schedule of a data stream transformation project more rapidly than conventional detailed software design processes. A vendor practicing the invention may determine the return on the investment for a data stream transformation project while it is in the evaluation stage, and may design the scope and schedule of a data stream transformation project free of charge. The qualification may be performed without the overhead cost of visiting the prospect's location.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

### APPENDIX A

### Prospect Qualification Form

Introduction

In order to efficiently and accurately prepare the preliminary requirements document and the subsequent quote, it is important to capture a complete description of the work to be performed. In order to facilitate the process, the following items should be prepared prior to the on-site visit by Orchid's engineering staff:

1. Business Initiative question section below must be completed before contacting Pre-Sales Engineer.

2. Customer contacts section below must be completed before contacting Pre-Sales Engineer.

3. Host Application Questionnaire for each Application to be ReShaped

4. New Connection Questionnaire

5. Planned Connectivity (network) diagram

6. List of additional customer deliverables for first meeting (see below)

7. Statement of Goals for first meeting

8. Mutual non-disclosure agreement with signature and copy

9. Schedule and cost calculation upon submission

Additional Customer Deliverables Due at First Meeting

1. Customer should be prepared to describe (and demonstrate) the operation of the existing host application. Written documentation including screen prints will be helpful.

2. Customer should be prepared to describe (at a general level) the content and flow of the new interface to be created and how it relates to the host interaction.

Goals for First Meeting

1. Items listed in checklist above, completely and accurately filled out.

2. Rough draft of Targeted Procedure Modeling (TPM).

1. What is Customer's Business Initiative?

Application integration—Web Ennoblement—Wireless—Data Migration—Public interface translation—Voice—Machine control

2. Why does the customer want to do this?

3. What client device(s) does the customer prefer, or have in mind?

4. If the new interface is HTML (Web) based, will the project be integrated with the customers existing web site (internal or external)?

5. What host application(s) will Orchid ReShape?

6. What host computer(s) do the application(s) run on?

7. What is the customers' timeline? What is influencing this?

8. What are the customers' alternatives?

9. What are the next action items for this opportunity?

10. Does the customer currently utilize teleconferencing? If so what kind?

### Customer Contacts

Business Contacts

1. Executive/Main Contact

Name
Address
Phone
No.
Mobile
No.
e-mail

2. Design Contact—who is the person responsible for working with Orchid before and during the TPM process to assure the Host and Connectivity Questionnaires are properly filled out and the TPM is created in a timely manner?

Name
Address
Phone
No.
Mobile
No.
e-mail

3. Project Manager—Who is the person responsible for overseeing the project as a whole?

Name
Address
Phone
No.
Mobile
No.
e-mail

4. Purchasing Contact

Name
Address
Phone
No.
Mobile
No.
e-mail

IS and Network Contacts

5. IS Contact—Who is the person responsible for overseeing integration of Orchid's TeleShaper into the customers network and establishing remote connectivity?

Name
Phone
No.
Mobile
No.
e-mail

6. Machine Room Contact—Name and number for “remote hands” support

Name
Phone
No.
Mobile
No.
e-mail

New Capabilities Contacts

7. End User Manager—Who is the manager responsible for overseeing the development of the new capabilities?

Name
Address
Phone
No.
Mobile
No.
e-mail

8. TPM Signoff—Who has the authority to approve targeted procedures model?

Name
Address
Phone
No.
Mobile
No.
e-mail

Host Application Contacts

9. Skilled User—Who is the person that is skilled in the use of the host application and that will be available to demonstrate the use of the application during the TPM phase and during the Shaper training phase?

Name
Phone
No.
Mobile
No.
e-mail

10. Skilled user's manager

Name
Phone
No.
Mobile
No.
e-mail

Notes

What is claimed is:

1. A system for remotely qualifying a prospect's data stream transformation project proposal, comprising:
a remote qualifier site including a phone, a fax machine, and a remote qualifier computer, further including a qualifier database, an e-mail client, a modem, and a Web browser;
a prospect site having a prospect phone, a prospect fax, and a host computer communicatively connected to the remote qualifier computer, further including a data storage device, host applications, a prospect e-mail client, a modem, and a prospect Web browser; and
wherein a remote qualifier may remotely qualify a prospect's data stream transformation project proposal using the phone, fax machine and remote qualifier computer to communicate with the prospect site to execute the steps of:
determining the prospect's business initiative;
determining if the prospect remains qualified after the previous step;
conducting a cost versus benefit analysis;
determining if the prospect remains qualified after the previous step;
determining a client device interface targeted by the data stream transformation project;
determining if the prospect remains qualified after the previous step;
inquiring about the prospect's host computer, host applications, network and interface;
determining if the prospect remains qualified after the previous step;
searching for similar prior data stream transformation projects;
determining if the prospect remains qualified after the previous step;
inquiring about deployment timing;
determining if the prospect remains qualified after the previous step;
inquiring about alternative approaches;
determining if the prospect remains qualified after the previous step;
rejecting the prospect as unqualified if the prospect was determined to be unqualified in a previous step;
requesting a signature on a mutual nondisclosure agreement;
determining whether the data stream transformation project may use a standard estimate or if it needs further development by an engineering team;
sending information regarding the data stream transformation project to a engineering team for an estimate if the data stream transformation project was determined to need further development, or generating a standard estimate if the data stream transformation project was determined not to need further development; and
gathering contact information.

2. The system of claim 1, further comprising an Internet host upon which the qualifier database may be alternatively stored, communicatively connected to the remote qualifier computer and host computer.

3. A method of remotely qualifying a prospect for a data stream transformation project, comprising the following remotely performed steps:
determining a prospect's business initiative;
determining if the prospect remains qualified after the previous step;
conducting a cost versus benefit analysis;
determining if the prospect remains qualified after the previous step;
determining a client device interface targeted by the data stream transformation project;
determining if the prospect remains qualified after the previous step;
inquiring about existing host systems of the prospect;
determining if the prospect remains qualified after the previous step;
searching for similar prior data stream transformation projects;
determining if the prospect remains qualified after the previous step;
inquiring about data stream transformation project deployment timing;
determining if the prospect remains qualified after the previous step;
inquiring about alternative approaches to accomplish the data stream transformation project;
determining if the prospect remains qualified after the previous step;
rejecting the prospect as unqualified if the prospect was determined to be unqualified in a previous step;
requesting a signature on a mutual nondisclosure agreement;
determining whether the data stream transformation project can use a standard estimate or if it needs further development by an engineering team;
sending information to a engineering team for an estimate if the data stream transformation project was determined to need further development, or alternatively generating a standard estimate if the data stream transformation project was determined not to need further development; and
gathering contact information.
